(19) United States
(12) Patent Application Publication
(10) Pub. No.: US 2025/0245582 A1
(43) Pub. Date: Jul. 31, 2025

(54) ACTIONABLE INSIGHTS SYSTEM FOR ANALYZED DATA IN ANALYTICS CLOUD APPLICATIONS

(71) Applicant: SAP SE, Walldorf (DE)

(72) Inventor: Lamine Rihani, Sartrouville (FR)

(21) Appl. No.: 18/981,993

(22) Filed: Dec. 16, 2024

Related U.S. Application Data
(60) Provisional application No. 63/616,040, filed on Dec. 29, 2023.

(51) Int. Cl. G06Q 10/0631; G06Q 10/0639

(52) U.S. Cl. CPC G06Q 10/063112; G06Q 10/0639

(57) ABSTRACT

Methods, software, and systems for automatic generation and assigning tasks to users based on intelligent analytics-enabled scheduling include: obtaining a data set including measurement data for data objects over a timeline and in relation to geographic locations; determining patterns in the data set associated with one or more of the data objects; executing a forecasting algorithm to generate a data analysis including predicted values for a data object of the data objects for a specified time period and a first geographic location of the geographic locations; and based on evaluating the generated data analysis, automatically assigning a task to be executed by a first user, the task being associated with the first geographic location, wherein automatically assigning the task comprises identifying the first user based on analyzing the predicted values of the data analysis.

### CLAIM OF PRIORITY

This application claims priority under 35 USC § 119(e) to U.S. Patent Application Ser. No. 63/616,040, filed on Dec. 29, 2023, the entire contents of which are hereby incorporated by reference.

### TECHNICAL FIELD

The present disclosure relates to computer-implemented methods, software, and systems for data processing.

### BACKGROUND

Software complexity is increasing and causes changes to the lifecycle management and maintenance of software applications, databases, and platform systems. In today's data-driven world, businesses are generating large volumes of data daily. Inefficient data analysis and reporting can be associated with inefficient utilization of resources and manpower. Challenges lie in analyzing and interpreting collected data to derive meaningful insights and make informed decisions.

### SUMMARY

Implementations of the present disclosure are generally directed to computer-implemented methods for automatic generation and assigning tasks to users based on intelligent analytics-enabled scheduling.

In some instances, this specification can be embodied in one or more methods (and also one or more non-transitory computer-readable mediums tangibly encoding a computer program operable to cause data processing apparatus to perform operations), including: obtaining a data set including measurement data for data objects over a timeline and in relation to geographic locations; determining patterns in the data set associated with one or more of the data objects; executing a forecasting algorithm to generate a data analysis including predicted values for a data object of the data objects for a specified time period and a first geographic location of the geographic locations; and based on evaluating the generated data analysis, automatically assigning a task to be executed by a first user, the task being associated with the first geographic location, wherein automatically assigning the task comprises identifying the first user based on analyzing the predicted values of the data analysis.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an example system that can execute implementations of the present disclosure.

FIG. 2A shows an example data analysis provided at a user interface of an analytical cloud application.

FIG. 2B shows an example scheduling request form to be used for configuring automatic communication of generated content for a predefined story (process or scenario) with a designated group of recipients.

FIG. 2C shows an example distribution list scheduler for defining recipients to receive shared information.

FIGS. 3A and 3B show an example workflow for actions assigned to stakeholders of different roles defined in a scheduling solution such as a calendar.

FIG. 4A shows an example method for automatically assigning tasks to users in accordance with implementations of the present disclosure.

FIG. 4B shows an example of content displayed at a user interface for a story “Sample—Revenue Analysis” generated as part of an analytics cloud solution.

FIGS. 4C and 4D include examples of how emails to sales representative can be generated.

FIG. 5 is a schematic illustration of example computer systems that can be used to execute implementations of the present disclosure.

Additional figures are depicted in the attached Appendix.

### DETAILED DESCRIPTION

In today's data-driven technology and business environments, effective communication and collaboration can be crucial for optimizing process execution (e.g., execution of decision-making processes) and improving the performance of task execution as related to the processes. In some implementations, an intelligent prescriptive dashboard scheduling and action item assignment system defining process and task execution based on analyzed data at an analytical software solution can be provided. In some instances, such a system (i.e., a dashboard scheduling and assignment generating system) can leverage advanced prescriptive analytics techniques to analyze complex data sets and generate actionable items based on derived insights from the data. Such actionable items can be generated according to a predefined plan including, for example, one or more key performance indicators (KPIs). By integrating an action item assignment system with an analytical software solution, scheduling an assignment of determined actions can be automated. For example, email content with comments and specific action items can be dynamically generated. In some instances, the generation of the email content and specific action items can be performed based on the analyzed data and defined plan including KPI(s). In some instances, the dashboard scheduling and assignment generating system can seamlessly integrate generative artificial intelligence (AI) techniques and scheduling capabilities to support and/or enhance decision-making processes, determine actions that can promote proactive task execution, and improve overall operational efficiency in an accurate manner.

In some cases, organizations can face significant challenges in efficiently managing and utilizing analyzed data. Traditional approaches to report sharing and action item assignment are often manual, time-consuming, and lack the ability to provide actionable insights in a timely manner. This can result in delayed decisions and overall process lifespan, missed action executions, suboptimal decision-making processes, and task execution that is based on identifying negative results rather than reducing the overall number of actions to be executed.

For example, the problems that can be addressed by implementations of the present disclosure include:
inefficient dashboard scheduling and information sharing processes,
limited actionable insights,
inconsistencies in communication, and
suboptimal resource allocation.

In some cases, the data can be updated within a structured predefined dashboard and broadcasted to a fixed list of recipients. However, that can impose limitations on the data sharing. In other cases, the data can be processed and distributed manually, which may require significant time and effort to generate and distribute reports to stakeholders. Lack of automation can lead to delays in report delivery, hindering real-time decision-making and limiting the ability to execute actions on time and matching the defined goal. Additionally, analyzed data often remains static, with little guidance on actionable steps to be taken based on the analysis. Without clear action items, decision-makers struggle to prioritize tasks, leading to missed opportunities for performance improvements. In some instances, inadequate utilization of prescriptive analytics can further exacerbate the problem. In accordance with the present implementations, prescriptive analytics techniques can be effectively utilized to generate insights and optimize decision-making by providing automation into task definition and execution.

In some instances, such techniques can support proactive task execution and can maximize operational efficiency, since utilization of computational resources can be reduced, while performance level can be maintained (e.g., as per the predefined plan and KPIs). For example, inconsistencies in communication stemming from traditional methods of sharing analyzed data and insights contribute to misinterpretations and delays. The lack of clear and standardized communication channels can affect collaboration and inhibit timely action. Additionally, suboptimal resource allocation resulting from inefficient scheduling processes can lead to underutilization or overload of resources. This, in turn, causes missed revenue opportunities, increased costs, and reduced overall performance. To address these challenges, an intelligent prescriptive analytics-enabled scheduling and actionable insights system can be configured to automate the scheduling process, integrate prescriptive analytics techniques, and generate actionable insights based on predefined KPIs and a goal achievement plan. By leveraging an analytical logic (e.g., implementing an analytics cloud application), this system can support timely report delivery, enhances decision-making through proactive action items, and facilitate efficient resource allocation. Such a solution improves performance and task execution, enables informed decision-making, and enhance competitiveness in the data-driven business data landscape.

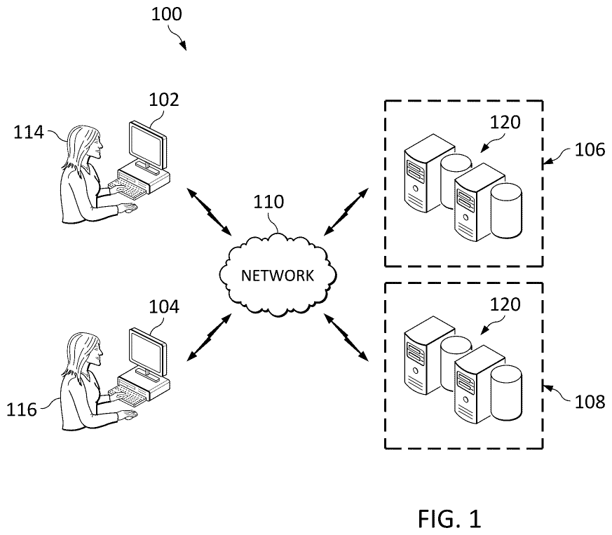

FIG. 1 depicts an example architecture 100 in accordance with implementations of the present disclosure. In the depicted example, the example architecture 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, an appropriate combination of any two or more of these devices, or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the cloud environment 106 includes at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines (VMs). A hosted application and/or service can run on VMs hosted on cloud infrastructure. In some instances, one application and/or service can run as multiple application instances on multiple corresponding VMs, where each instance is running on a corresponding VM.

In some instances, such hosted applications or services running in the cloud environment 106 can be tested, for example, based on automatically generated test cases in accordance with the present disclosure.

In accordance with implementations of the present disclosure, a combination of large language model technologies and intelligent algorithms can be implemented at the cloud environments 106 and/or 108 to automate scheduling, determine a relevant recipient list, generate relevant customized email communication, and create targeted action items. Implementations of the present disclosure can leverage the capabilities of an analytics cloud application to seamlessly integrate with data analysis and reporting functionalities, providing a comprehensive and user-friendly platform for decision-making.

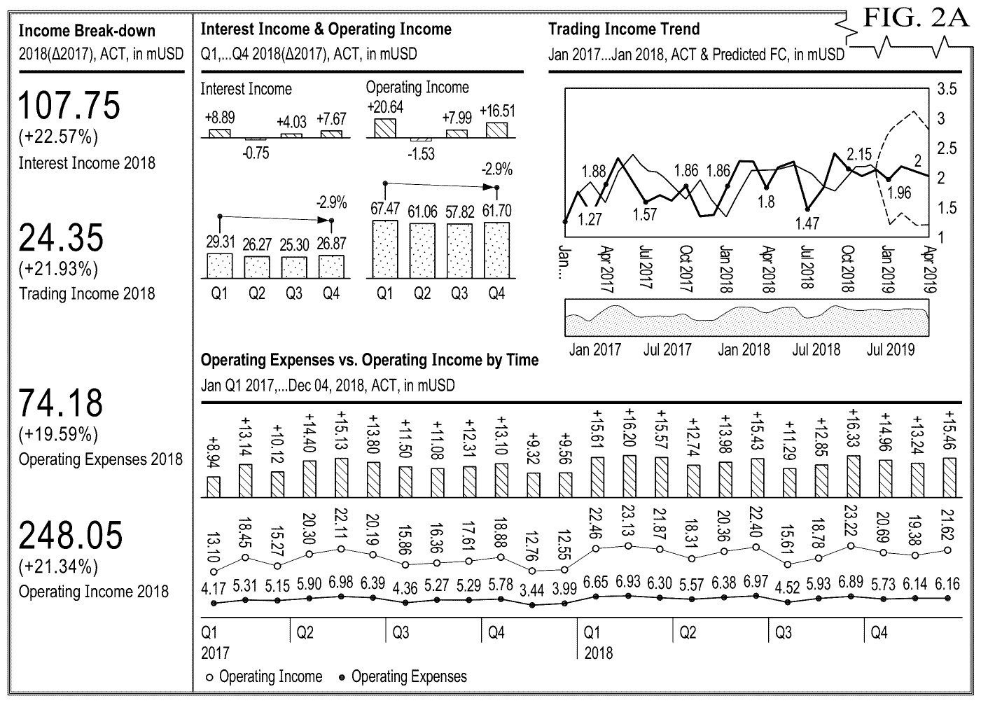

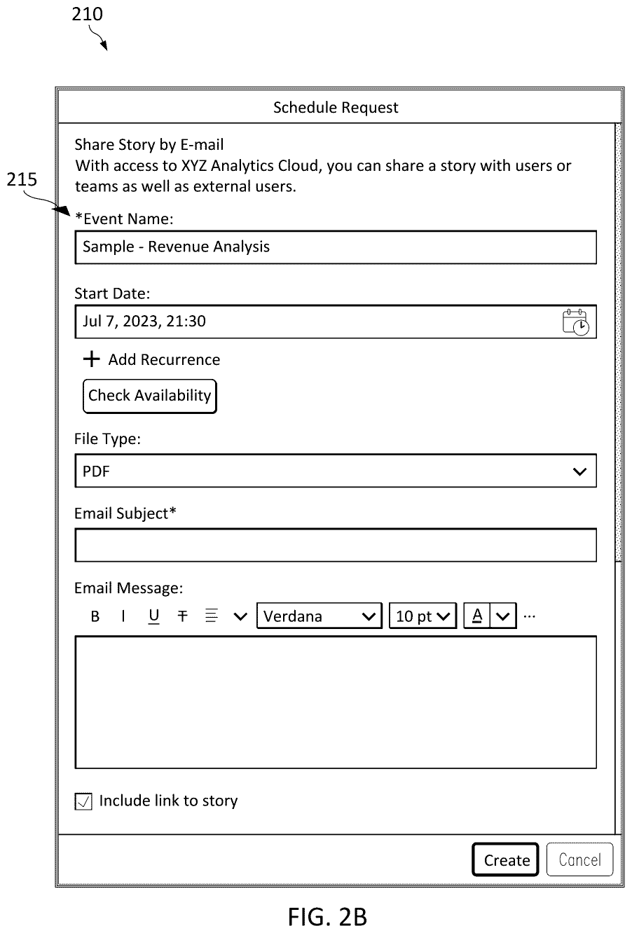

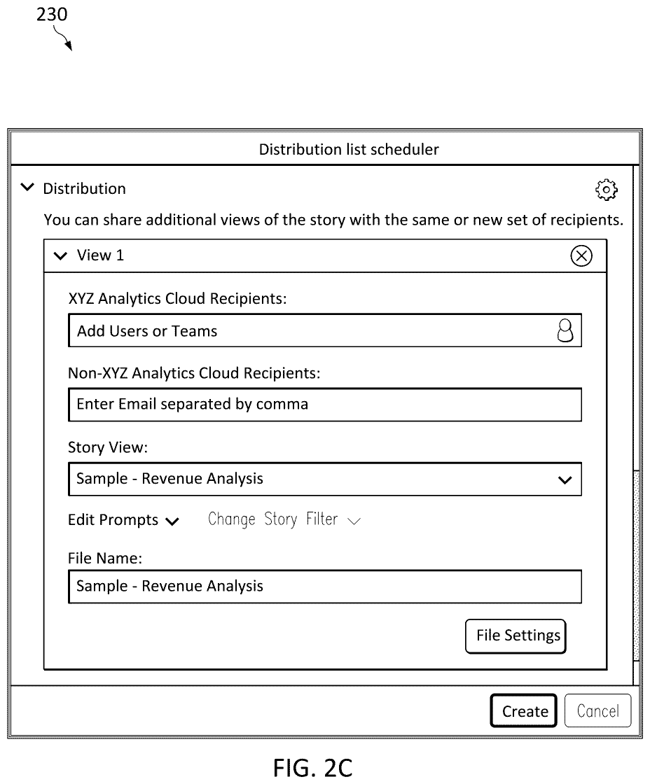

FIG. 2A shows an example data analysis provided at a user interface 200 of an analytical cloud application. The analytical cloud application can implement data analysis and reporting functionalities. The user interface 200 can be provided as part of multiple interfaces implemented for the analytical cloud application to provide a view of analyzed data including text description, numbers, or graphical representation of the values in different analytical forms (bar charts, graphics, plotted time series data, etc.), among other examples.

The user interface 200 represents a dashboard that can be generated and used to share a defined story (process or scenario) at a predefined date and/or time, or according to a schedule or generation pattern. In some instances, a predefined story can be a data analysis, such as an analysis of measurement data collected for data objects. The data analysis can be performed over time series data associated with data objects. The data analysis can include diagrams or charts that represent trends in the measurement data over a timeline and that are associated with geographical locations. For example, the data analysis can be associated with plotting revenue collection for each month of a given year at multiple locations, such as countries, cities, regions, or otherwise defined.

In some implementations, the user interface 200 can be provided to the display of a device of a recipient, where the generation and sharing of the content can be according to a defined event for a defined story. For example, the event can be defined as a recurring date associated with multiple occurrences associated with a particular date and time (e.g., hourly, weekly, monthly, etc.). For example, a report can be generated each first Monday of a month, each Monday of each week, every day, every two hours, or according to another generation's schedule. Upon generating the report, the currently relevant data at that date and time can be used to provide an updated and current view of the data representation, e.g., through a report, diagram, chart, or otherwise.

In some instances, data obtained through an analytical cloud application, for example, measurement data associated with data objects (e.g., sales revenue from products at various locations around the world) can be processed and used to generate the content of the dashboard for a particular story representation in a particular format. For example, the user interface 200 provides analytical data for operating income and expenses for a period of time, i.e., between the beginning of 2017 until the end of 2018. The generation of the content on the user interface 200 can be provided to the end user through an email, for example, with a predefined email subject and message. For example, the communication that can be automatically generated and an email form, such as the one shown at FIG. 2B, can be created for use when communicating the generated dashboard.

FIG. 2B shows an example of a scheduling request form 210 to be used for configuring automatic communication of generated content for a predefined story (process or scenario) with a designated group of recipients. In some instances, the automatically generated content can be created for a predefined story upon identifying a triggering event for the content generation. The content can be presented as a dashboard including content according to predefined rules and in particular formats, for example, as shown on the user interface 200 of FIG. 2A. In some instances, based on a configured communication schedule, emails for sharing the content can be generated and distributed to recipients. For example, the email can be configured to be generated according to definitions for the email in the scheduling request form 210. Generated content for an identified story can be shared through an email and according to a predefined email template. As shown on FIG. 2B, the configuration of the scheduling of email sharing can be defined for a particular event, for example, an event named “Sample—Revenue Analysis” 215, that is defined for sharing a story predefined for that particular event (identified based on, e.g., an event name, event identifier, otherwise). The scheduling request form 210 can be associated with automatic content generation according to the implemented logic for a particular story.

In some instances, an automated scheduling solution can be implemented to generate content related to predefined stories with a fixed list of users or teams as well as external users, or a dynamic list relying on a data dimension that can include email address. The definition of the content, the type, the content of the communication (e.g., email with a particular subject line, etc.), and scheduling parameters can be configured within the scheduling solution. The scheduling request form 210 can be implemented as part of the scheduling solution and can associate the scheduling of event sharing with the definition of events and respective content generation for the particular event (e.g., content generated for a revenue analysis).

FIG. 2C shows an example distribution list scheduler 230 for defining recipients to receive shared information. The distribution list scheduler 230 can be automatically populated with recipients (e.g., subjects identified as users) that are determined for the type of a story (e.g., sale revenue reports may be defined to be shared with a predefined group of users associated with a distribution list, associated with a particular role such as marketing managers, or individually identifier). The recipient list can be defined to include internal users to a given network (e.g., a corporate network) or external users.

The present application discloses a new solution that proposes enhancements, e.g., to old solutions, that can significantly improve the performance of scheduling and providing actionable insight based on the provided analyzed data. In accordance with implementations of the present disclosure, personalized email content can be generated for each recipient (e.g., through the schedule request form 210 of FIG. 2B), incorporating relevant comments, insights, and action items based on analyzed data (e.g., analyze data for a particular predefined story, analyzed historical data for previously defined actions and distribution to users, predefined objectives for performance associated with measurement data used for the generation of the predefined story, etc.). This dynamic content generation can ensure that the email communication is tailored to each recipient's specific needs and responsibilities, facilitating clear understanding and targeted actions.

In some instances, a system can be implemented to provide real-time monitoring of scheduling performance and feedback on action item execution. This allows for continuous optimization of the scheduling process based on user feedback and evolving business needs. The feedback loop enables iterative improvements to the system, resulting in more accurate insights and enhanced scheduling performance over time. In some instances, by leveraging an existing predictive analytics service as part of an analytics solution, key aspects of the current scheduling feature can be improved. Specifically, the recipient selection process can be optimized, and the timing of dashboard delivery can be improved. By building upon smart algorithms already embedded in an analytics cloud solution, greater intelligence (including insight, data analysis, definition of content generation, task patterns, etc.) can be embedded into these scheduling functionalities, as in the below listed key aspects.

### Smart Triggering

In some instances, a scheduling solution for distributing predictive data can implement smart triggering features to enhance the distribution process of stories (e.g., dashboards or other forms of data analysis) within an analytics cloud solution. Such enhancement leverages intelligent algorithms and predefined KPI plans (e.g., defining achievement goals, performance goals, etc.) to determine an optimal timing and frequency of distributing the stories. Smart triggering can incorporate features such as:

### 1) Predictive Algorithms

A scheduling system can utilize advanced algorithms to evaluate and consider various factors, including historical performance, data trends, and business objectives to determine when and what type of content to be generated for sharing with relevant participants. These algorithms can assess the optimal timing and frequency for distributing the stories to maximize their impact and relevance.

### 2) Predefined KPI Achievement Plan

Stakeholders can define specific KPIs along with their performance plans or predefined milestones for achieving quantitative goals associated with measurement data for data objects. For example, the achievement plan can outline target thresholds, desired time frames, and milestones for reaching the set objectives.

### 3) Optimal Timing and Frequency

The scheduling system can combine insights from predictive algorithms (e.g., algorithms used to analyze data and generate data analysis to be performed in the shape of dashboards, reports, graphics, or otherwise) and predefined achievement plans to determine the most suitable timing and frequency for distributing the stories.

By incorporating smart triggering into the scheduling process, the scheduling system can enhance the distribution of stories by ensuring they are shared at the right time and frequency for maximum impact. This approach ensures that the distributed insights align with the achievement plans defined for the relevant KPIs.

### Stakeholders' Determination

The scheduling solution can be configured to analyze story content, performance factors (e.g., KPIs), performance or achievement plans, or other relevant factors to determine responsible stakeholders (e.g., users defined with roles at the scheduling solution and/or at the cloud analytics solution) who should be added to a recipient list of the story publication. The stakeholders' determination can be implemented as a function that enables a more precise and efficient communication by ensuring that the right stakeholders receive the relevant insights and action items. This functionality can offer several benefits:
Targeted Communication: By analyzing story content and aligning it with the responsible stakeholders, the scheduling system can ensure that insights are communicated to the individuals who can directly act upon them. This targeted approach minimizes information overload and enhances the relevance of the insights for each stakeholder.
Accountability and Ownership: The Stakeholders' definition reinforces accountability by assigning responsibility to the appropriate stakeholders based on the KPI achievement plans.
Actionable Insights Generation: Based on the analysis results, the solution generates actionable insights for stakeholders. These insights are derived from the analyzed data and provide valuable information for driving proactive actions. Action items are dynamically assigned to relevant stakeholders.

In some implementations, an intelligent prescriptive analytics-enabled scheduling and actionable insights system (e.g., a scheduling system) can leverage advanced analytics, automation, and integration capabilities within an analytics cloud solution. By seamlessly integrating data analysis, automated scheduling, actionable insights generation, and collaboration features, this solution empowers decision-makers with timely and relevant information, facilitates proactive actions, and drives improved business performance.

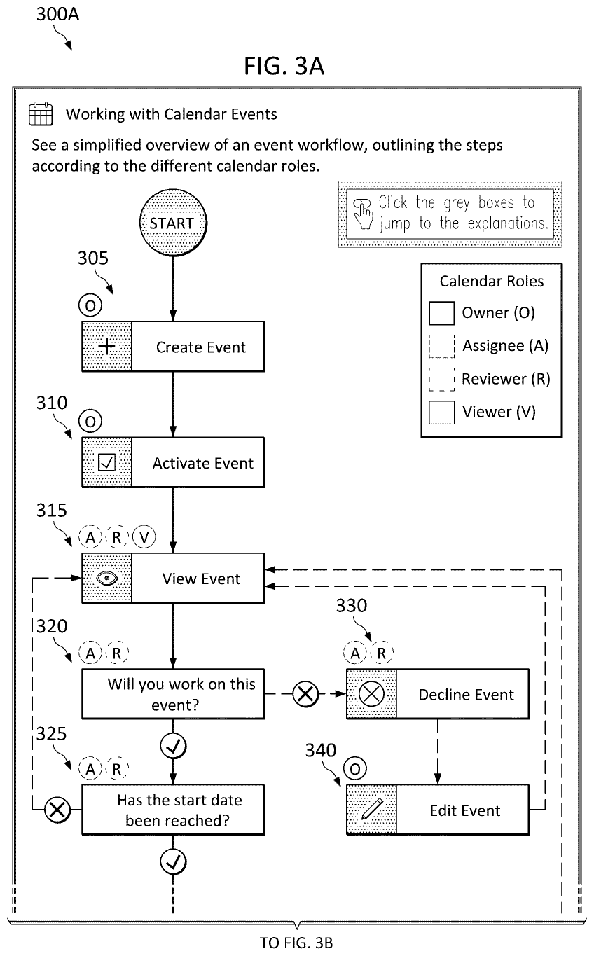

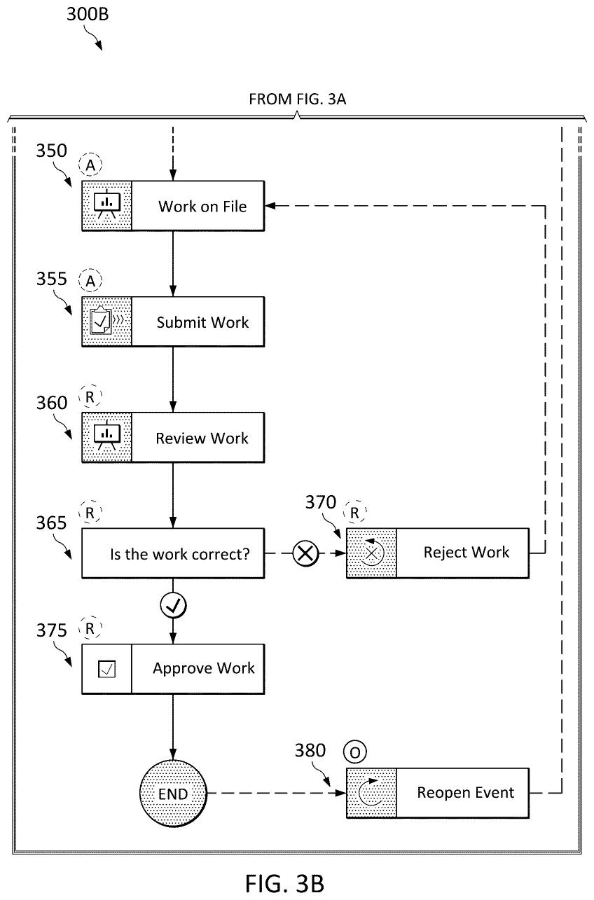

FIGS. 3A and 3B show an example workflow 300 for actions assigned to stakeholders of different roles defined in a scheduling solution such as a calendar. The example workflow 300 can be defined as a scheduling solution in accordance with the present implementations.

In some implementations, based on evaluating a data part, that is a part of a data analysis, action insights can be generated for relevant stakeholders that can be defined as recipients for the actions. The example workflow 300 includes multiple items that are assigned to recipients who have different roles and require execution of actions as defined during the workflow generation. The workflow definition can be generated based on evaluating the data analysis and identifying a smart trigger to initiate the execution of the example workflow 300. Different roles can be defined for the users of the system where the example workflow 300 is executed. At 305, an event can be created by a user who has the role of an owner of the workflow 300. For example, the event can be an actionable item to be performed by a user, such as a salesperson, for a particular product at a particular location. In particular, the event can be a sales event associated with selling kid toys at a store in San Francisco. The sales event can be relevant for users associated with handling sales events for such products at that location or can be assigned to other recipients having a particular role that can match a defined rule for assigning users to the type of event (e.g., a salesperson who has revenue performance meeting a criterion for a sales event in that location or for that type of products). The created event can be activated by a user who is the owner of the workflow 300. The activated event can become viewable for multiple other rules having a role different from the owner's role. For example, the view event 315 can be available to a recipient of the event who is with a role assignee, reviewer, and viewer. For example, the roles can be predefined for the workflow or for multiple workflows that can be already created within a scheduling application such as a calendar scheduler. The users assigned to an item of the workflow 300 can perform actions based on the specifics of the item and their respective roles.

At 320, the event 315 can be viewed by users and processed by recipients who are assigned to work on the event, e.g., an assignee or reviewer (but not a mere viewer), and each user can perform actions in response to the event 315. At 330, it can be determined that neither the assignee nor the reviewer would accept the event, and the view event is identified as declined. When the event is declined, the event can be edited (at 340) by the user who is the owner of the workflow 300 so that the view event 315 is defined and can be processed again at 320. If the event is accepted to be processed by a user, such as an assignee or a reviewer, a determination of a start date for the event can be made at 325. If the start date has not yet been reached, other events that are created, for example, as part of the workflow 300 can be reviewed.

When a user receives an assigned task as defined in an event that has been identified to have started (e.g., as determined at 325), the user can work on the assigned task as part of the event at 350. The user can submit a work product at 355, and the work product can be assigned to a reviewer user to perform a review at 360. The workflow 300 can define for each item of the workflow 300 a relevant stakeholder (i.e., user or a user role) to perform respective actions. At 360, the reviewer can access the work product of the assignee as submitted at 355, and at 365, it can be determined whether the work is correct. If the work is not correct, at 370, the work can be rejected, and the workflow 300 can trigger an action for the assignee to work on the file back at item 350. If the work is approved at 375, the workflow 300 can be terminated. Working on tasks associated with the event can be triggered again later, for example, at 380, when an owner of the workflow 300 reopens the event and triggers working on the file as defined at 350.

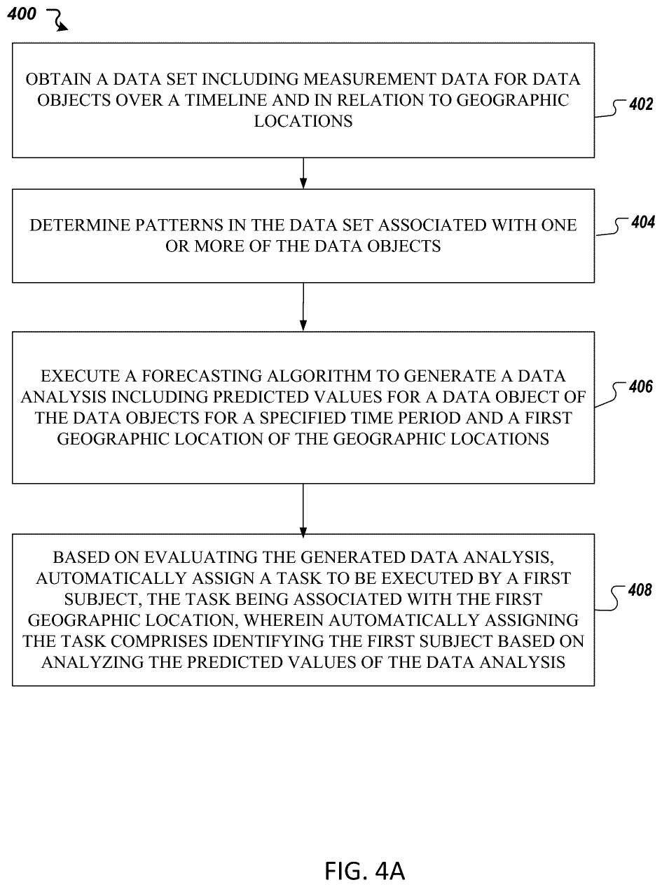

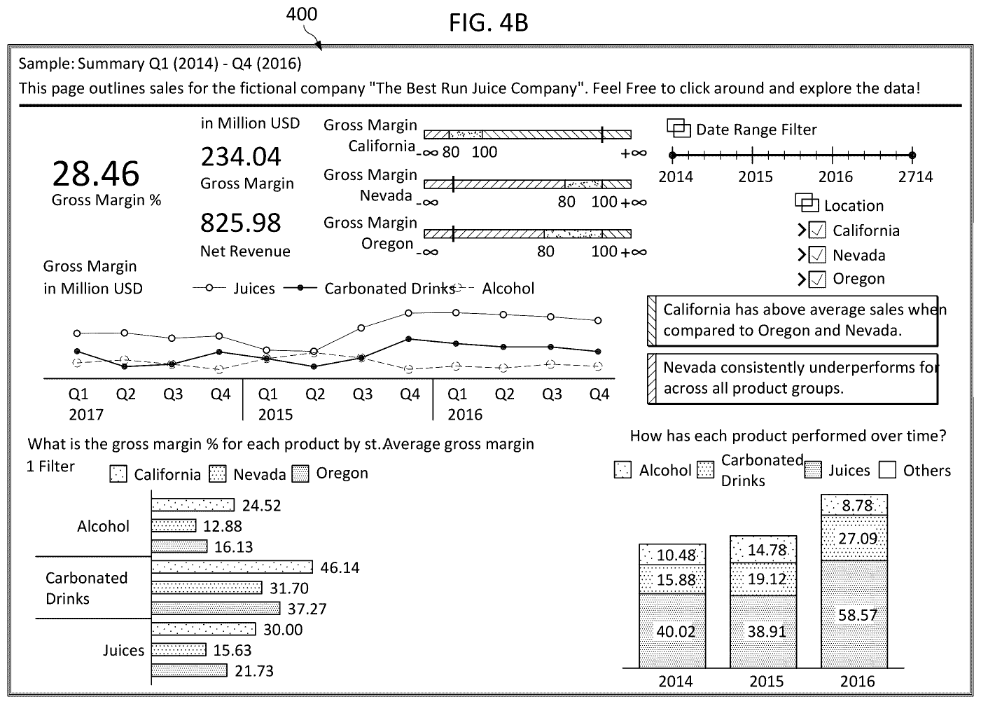

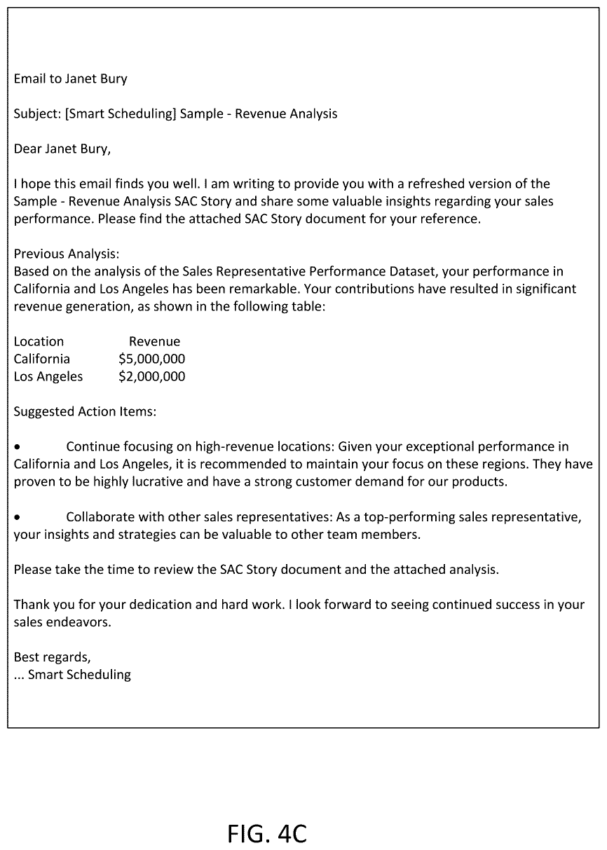

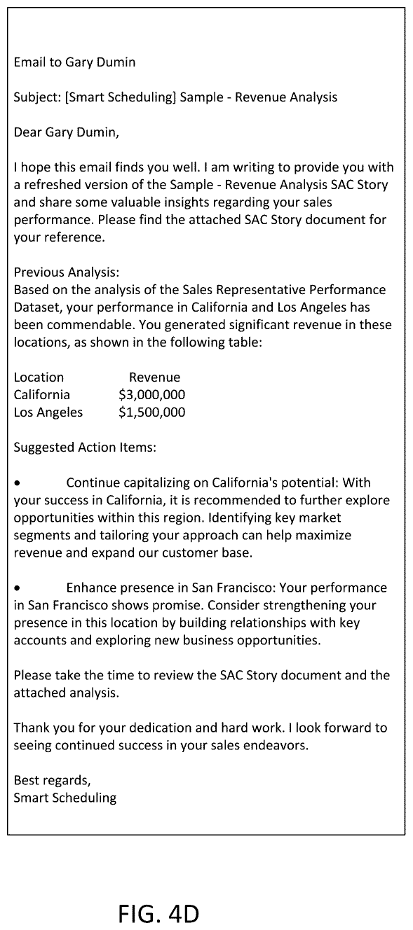

FIG. 4A shows an example method 400 for automatically assigning tasks to users in accordance with implementations of the present disclosure. The example process 400 can be executed at a scheduling solution integrated with analytics logic (e.g., such as analytics logic implemented at an analytics cloud solution)

At 402, a data set can be obtained. The data set includes measurement data for data objects over a timeline and in relation to geographic locations (e.g., countries, cities, regions, continents, or other location definitions).

At 404, patterns in the data set associated with one or more of the data objects can be determined.

At 406, a forecasting algorithm can be executed to generate a data analysis including predicted values for a data object of the data objects for a specified time period and a first geographic location of the geographic locations.

Based on evaluating the generated data analysis, automatically assigning of a task to be executed by a first user can be performed at 408. The task can be associated with the first geographic location. Automatically assigning the task comprises identifying the first user based on analyzing the predicted values of the data analysis.

The automatic assignment of the task to be executed by the first user can include generating a definition for the task (e.g., work on a file as described in relation to item 350 of FIG. 3B) to be performed in relation to the data object. The definition for the task can be associated with defining a quantity (e.g., units of measure for a product or matter) associated with the data object to be allocated to the first geographic location for the specified time period.

In some instances, identifying the first user can be based on evaluating the performance data of a plurality of users, the plurality of users being identified as associated with at least one of the geographic locations related to the measurement data for the data objects.

In some instances, the method 400 can include receiving input defining factors for scheduling tasks. Based on the evaluation of the input, a schedule for the assigned task can be automatically generated. The assigned task can be defined in the schedule to be executed by one or more users, including the first user. The one or more users can be associated with measurement data for instances of data objects from the data set, where the instances of the data objects are associated with the first geographic location. For example, the users can be associated with selling products of a particular type in a particular geographical region corresponding to the first geographic location.

In some instances, generating the schedule for the assigned task can include: performing data analytics over historical data associated with the first geographic location and a plurality of users; obtaining assignment factors including performance objectives associated with the data objects; and automatically identifying the schedule based on evaluating the data analytics over the historical data according to the assignment factors.

In some instances, new measurement data for the data objects can be collected and evaluated so that activities associated with the data objects can be monitored continuously. The monitoring can support the dynamical identification of smart triggers to initiate a task, for example, trigger an execution of a workflow as described in relation to FIGS. 3A and 3B.

FIG. 4B shows an example of the content displayed at a user interface 400 for a story “Sample—Revenue Analysis” generated as part of an analytics cloud solution. The content can be shared with end users based on a dynamic email content generator as described in relation to FIGS. 2A, 2B, and 2C, where when the email notification with the content is provided to a recipient, the recipient can activate the content and display it at a relevant user interface, such as the user interface 400.

An intelligent prescriptive analytics-enabled scheduling and actionable insights system can be integrated within an analytics cloud solution. For example, a beverage distribution company operating in different locations (California, Los Angeles, San Francisco, etc.). The company deals with various products (Alcohol, Carbonated Drinks, Juices, etc.) and employs a team of sales representatives to manage sales in each location. The goal is to optimize the scheduling of sales representatives based on historical data and predictive analytics.

### Customer Demand Dataset

A customer demand dataset can be obtained that includes information about the sales revenue generated by different products (Alcohol, Carbonated Drinks, Juices) over time (quarters, months, etc.) in each location. The dataset can be used to identify demand patterns, seasonality, and customer preferences for different products in different periods.

### Sales Representative Performance Dataset

A sales representative performance dataset can be obtained to be evaluated and to provide insights into the performance of sales representatives, such as their individual sales revenue, region-wise performance, and historical trends. Such data can help evaluate the effectiveness and efficiency of a sales representative in generating revenue.

### Location Revenue Dataset

This dataset can include the net revenue generated by the company in various locations over time. It helps understand the overall performance of each location and identify high-revenue and low-revenue areas.

By combining these datasets and applying intelligent prescriptive analytics techniques, the following insights and actions can be derived.

### Demand Forecasting

By analyzing historical data from the customer demand dataset, predictive analytics techniques can be applied to forecast the future demand for different products in each location. This helps the company predict the expected sales revenue for specific periods and locations. Table 1 is an example prediction for the expected sales revenue per quarter and for a particular location for products including alcohol, carbonated drinks, and juices, generated based on implementations according to the present disclosure.

TABLE 1

| Date | Product | Revenue |
|---|---|---|
| Q1 | Alcohol | 10,000,000 |
| Q1 | Carbonated Drinks | 15,000,000 |
| Q1 | Juices | 20,000,000 |
| Q2 | Alcohol | 8,000,000 |
| Q2 | Carbonated Drinks | 12,000,000 |
| Q2 | Juices | 18,000,000 |
| . . . | . . . | . . . |

### Sales Representative Allocation

By analyzing the sales representative performance dataset, a company (or an account defined at a scheduling application including multiple users with predefined user roles and configurations) can identify top-performing sales representatives and assign them to high-revenue or high-demand locations. This ensures that the most effective sales representatives are allocated to locations where they can generate the highest revenue. Table 2 shows an example of sales representative allocation generated based on implementations according to the present disclosure.

TABLE 2

| Sales Representative | Location | Revenue |
|---|---|---|
| Janet Bury | California | 5,000,000 |
| Janet Bury | Los Angeles | 2,000,000 |
| Gary Dumin | California | 3,000,000 |
| Gary Dumin | San Francisco | 1,500,000 |
| . . . | . . . | . . . |

### Schedule Optimization:

Using the location revenue dataset, along with demand forecasting and sales representative availability, the company can optimize sales representative schedules. Factors such as peak demand periods, travel distances, and location-specific requirements can be considered to create efficient and effective schedules for sales representatives. Table 3 shows an optimized schedule generated based on implementations according to the present disclosure.

TABLE 3

| Location | Net Revenue |
|---|---|
| California | 50,000,000 |
| Los Angeles | 20,000,000 |
| San Francisco | 15,000,000 |
| . . . | . . . |

### Performance Evaluation and Adjustment:

By continuously monitoring the sales revenue generated by each sales representative and comparing it against the forecasted revenue, the company can evaluate performance. Any discrepancies or deviations from expected performance can be identified, and necessary adjustments in terms of resource allocation, training, or scheduling can be made. Table 4 shows an example performance evaluation per sales representative generated based on implementations according to the present disclosure.

TABLE 4

| Sales Representative | Location | Revenue |
|---|---|---|
| Janet Bury | California | 5,000,000 |
| Janet Bury | Los Angeles | 2,000,000 |
| Gary Dumin | California | 3,000,000 |
| Gary Dumin | San Francisco | 1,500,000 |
| . . . | . . . | . . . |

These data tables demonstrate how the original datasets are utilized in each section to enable intelligent prescriptive analytics-enabled scheduling. FIGS. 4C and 4D include examples of how custom emails to each sales representative could be generated, including the story as an attachment, previous analysis with data tables, and suggested action items.

Similarly, custom emails can be generated for each sales representative, tailoring the analysis and action items according to their specific performance and locations.

### Advantages of the Present Implementations

The implementations of the present disclosure provide actionable insights and personalized recommendations based on advanced analytics techniques. This empowers decision-makers to make informed choices and take proactive actions to drive performance improvements. The proposed solutions provide multiple technical advantages including:
Optimized scheduling process: By automating the scheduling process, the solution ensures timely report delivery to the right stakeholders. This saves time, improves efficiency, and enables real-time decision-making based on up-to-date information.
Customization and personalization: The system allows for the customization of scheduling options, targets, and action items based on specific user preferences and dimensions. This customization ensures that insights and actions are tailored to individual roles, regions, or other relevant factors, promoting relevance and effectiveness.
Improved collaboration and accountability: Integration with collaboration tools facilitates seamless communication, collaboration, and tracking of action items. This promotes accountability among stakeholders, enhances teamwork, and ensures that recommended actions are implemented and monitored effectively.
Proactive action and performance improvement: By generating dynamic action items based on analyzed data, the solution enables proactive actions to address performance gaps, capitalize on opportunities, and optimize business outcomes. This promotes a culture of continuous improvement and enables organizations to stay ahead of the competition.
Real-time monitoring and iterative optimization: The system provides real-time monitoring of scheduling performance and action item execution. User feedback and evolving business needs are used to continuously optimize the scheduling process, ensuring that insights and actions remain accurate and relevant over time.
Seamless integration with an analytics cloud solution: Leveraging the capabilities of the analytics cloud, the solution seamlessly integrates with data analysis and reporting functionalities. This allows for a comprehensive and unified platform, reducing the need for multiple tools and providing a seamless user experience.
Improved resource allocation: By providing actionable insights and performance monitoring, the solution enables optimized resource allocation. Organizations can allocate their resources more effectively, focusing efforts on areas that have the greatest potential for impact and improvement.
The intelligent prescriptive analytics-enabled scheduling and actionable insights system for Analyzed Data in the analytics cloud. This offers significant advantages in terms of data-driven decision-making, efficient scheduling, collaboration, performance improvement, and resource optimization. By leveraging advanced analytics techniques and integrating with the Analytics Cloud solution, organizations can gain valuable insights, drive proactive actions, and achieve better business outcomes.

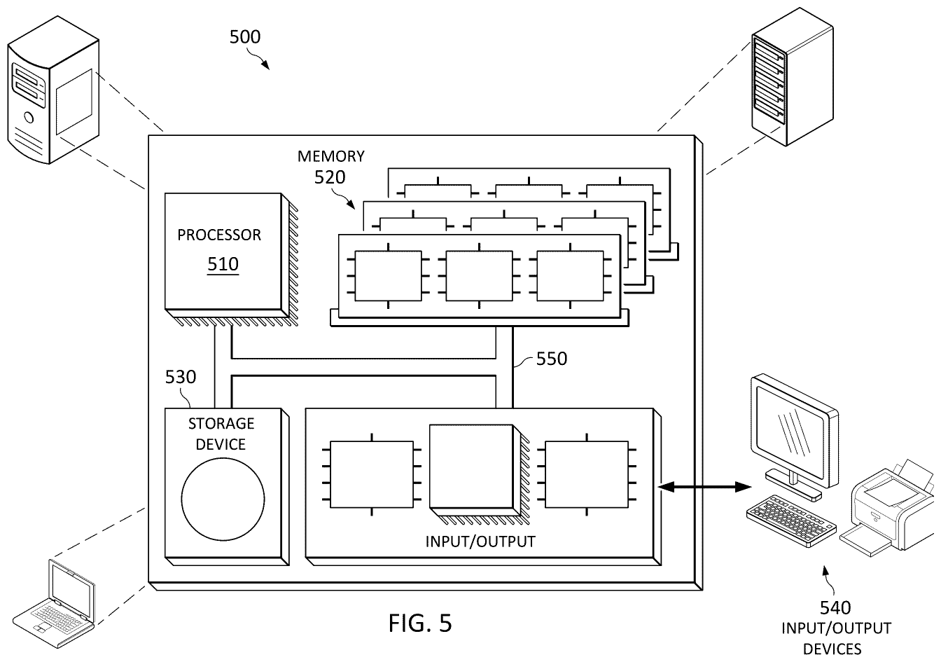

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. In other implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory, a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, that includes a middleware component, such as an application server or an Internet server, or a front-end component, such as a client computer having a graphical user interface or an Internet browser, or any combination of them. The components of the system can be connected by any form or medium of digital data communication, such as a communication network. Examples of communication networks include, for example, a LAN, a WAN, and the computers and networks forming the Internet.

The computer system can include clients and servers. A client and server are generally remote from each other and typically interact through a network, such as the described one. The relationship of a client and server arises by virtue of computer programs running on the respective computers and having a client-server relationship with each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure.

### EXAMPLES

Although the present application is defined in the attached claims, it should be understood that the present invention can also (alternatively) be defined in accordance with the following examples:

Example 1. A computer-implemented method comprising:
obtaining a data set including measurement data for data objects over a timeline and geographic locations;
determining patterns in the data set associated with one or more of the data objects;
executing a forecasting algorithm to predict values for an object of the data objects for a specific time period and a geographic location; and
based on the executed forecasting algorithms, automatically assigning a task to be executed by a subject, the task being associated with the geographic location, and the subject being identified based on analyzing the predicted values.

Example 2. The method of Example 1, comprising:
receiving input defining factors for scheduling tasks; and
based on evaluation of the input, automatically generating a schedule to optimize scheduling tasks to subjects, wherein the subjects are associated with measurement data for instances of data objects from the data set.

Example 3. The method of Example 1 or Example 2, wherein the measurement data includes revenue data for products as data objects.

Example 4. The method of any one of the preceding Examples, wherein the timeline is defined according to a scale including discrete time ranges.

Example 5. The method of any one of the preceding Examples, comprising:
periodically collecting new measurement data for the data objects; and
performing continuous monitoring of activities associated with one or more data objects, wherein each activity is associated with at least a portion of the new measurement data.

Example 6. A system comprising:
one or more processors; and
one or more computer-readable memories coupled to the one or more processors and having instructions stored thereon that are executable by the one or more processors to perform the method of any of Examples 1 to 5.

Example 7. A non-transitory, computer-readable medium coupled to one or more processors and having instructions stored thereon which, when executed by the one or more processors, cause the one or more processors to perform the method of any of Examples 1 to 5.

What is claimed is:

1. A computer-implemented method comprising:
obtaining a data set including measurement data for data objects over a timeline and in relation to geographic locations;
determining patterns in the data set associated with one or more of the data objects;
executing a forecasting algorithm to generate a data analysis including predicted values for a data object of the data objects for a specified time period and a first geographic location of the geographic locations; and
based on evaluating the generated data analysis, automatically assigning a task to be executed by a first user, the task being associated with the first geographic location, wherein automatically assigning the task comprises identifying the first user based on analyzing the predicted values of the data analysis.

2. The method of claim 1, wherein automatically assigning the task to be executed by the first user comprises:
generating a definition for the task to be performed in relation to the data object, wherein the definition for the task is associated with defining a quantity associated with the data object to be allocated to the first geographic location for the specified time period.

3. The method of claim 1, wherein identifying the first user comprises identifying the first user based on evaluating performance data of a plurality of users, the plurality of users being identified as associated with at least one of the geographic locations related to the measurement data for the data objects.

4. The method of claim 1, comprising:
receiving input defining factors for scheduling tasks; and
based on evaluation of the input, automatically generating a schedule for the task to be executed by one or more users including the first user, wherein the one or more users are associated with measurement data for instances of data objects from the data set, wherein the instances of the data objects are associated with the first geographic location.

5. The method of claim 4, wherein generating the schedule for the assigned task comprises:
performing data analytics over historical data associated with the first geographic location and a plurality of users;
obtaining assignment factors including performance objectives associated with the data objects; and
automatically identifying the schedule based on evaluating the data analytics over the historical data according to the assignment factors.

6. The method of claim 1, wherein the data objects are defined for products, and wherein the measurement data includes revenue data for the products at time points over the timeline.

7. The method of claim 1, wherein the measurement data includes time series data for the data object, and wherein the time series data is associated with a plurality of time points defined over the timeline, wherein each time point is associated with one or more of the geographic locations.

8. The method of claim 1, wherein the timeline is defined according to a scale including discrete time ranges.

9. The method of claim 1, comprising:
periodically collecting new measurement data for the data objects; and
performing continuous monitoring of activities associated with one or more data objects, wherein each activity is associated with at least a portion of the new measurement data.

10. A system comprising:
one or more processors; and
one or more computer-readable memories coupled to the one or more processors and having instructions stored thereon that are executable by the one or more processors to perform operations comprising:
obtaining a data set including measurement data for data objects over a timeline and in relation to geographic locations;
determining patterns in the data set associated with one or more of the data objects;
executing a forecasting algorithm to generate a data analysis including predicted values for a data object of the data objects for a specified time period and a first geographic location of the geographic locations; and
based on evaluating the generated data analysis, automatically assigning a task to be executed by a first user, the task being associated with the first geographic location, wherein automatically assigning the task comprises identifying the first user based on analyzing the predicted values of the data analysis.

11. The system of claim 10, wherein automatically assigning the task to be executed by the first user comprises:
generating a definition for the task to be performed in relation to the data object, wherein the definition for the task is associated with defining a quantity associated with the data object to be allocated to the first geographic location for the specified time period.

12. The system of claim 10, wherein identifying the first user comprises identifying the first user based on evaluating performance data of a plurality of users, the plurality of users being identified as associated with at least one of the geographic locations related to the measurement data for the data objects.

13. The system of claim 10, wherein the one or more computer-readable memories further include instructions, which when executed cause the one or more processors to perform operations comprising:
receiving input defining factors for scheduling tasks; and
based on evaluation of the input, automatically generating a schedule for the task to be executed by one or more users including the first user, wherein the one or more users are associated with measurement data for instances of data objects from the data set, wherein the instances of the data objects are associated with the first geographic location.

14. The system of claim 13, wherein generating the schedule for the assigned task comprises:
performing data analytics over historical data associated with the first geographic location and a plurality of users;
obtaining assignment factors including performance objectives associated with the data objects; and
automatically identifying the schedule based on evaluating the data analytics over the historical data according to the assignment factors.

15. The system of claim 10, wherein the data objects are defined for products, and wherein the measurement data includes revenue data for the products at time points over the timeline.

16. A non-transitory, computer-readable medium coupled to one or more processors and having instructions stored thereon which, when executed by the one or more processors, cause the one or more processors to perform operations comprising:
obtaining a data set including measurement data for data objects over a timeline and in relation to geographic locations;
determining patterns in the data set associated with one or more of the data objects;
executing a forecasting algorithm to generate a data analysis including predicted values for a data object of the data objects for a specified time period and a first geographic location of the geographic locations; and
based on evaluating the generated data analysis, automatically assigning a task to be executed by a first user, the task being associated with the first geographic location, wherein automatically assigning the task comprises identifying the first user based on analyzing the predicted values of the data analysis.

17. The computer-readable medium of claim 16, wherein automatically assigning the task to be executed by the first user comprises:
generating a definition for the task to be performed in relation to the data object, wherein the definition for the task is associated with defining a quantity associated with the data object to be allocated to the first geographic location for the specified time period.

18. The computer-readable medium of claim 16, wherein identifying the first user comprises identifying the first user based on evaluating performance data of a plurality of users, the plurality of users being identified as associated with at least one of the geographic locations related to the measurement data for the data objects.

19. The computer-readable medium of claim 16, further storing instructions, which when executed cause the one or more processors to perform operations comprising:
receiving input defining factors for scheduling tasks; and
based on evaluation of the input, automatically generating a schedule for the task to be executed by one or more users including the first user, wherein the one or more users are associated with measurement data for instances of data objects from the data set, wherein the instances of the data objects are associated with the first geographic location.

20. The computer-readable medium of claim 19, wherein generating the schedule for the assigned task comprises:
performing data analytics over historical data associated with the first geographic location and a plurality of users;
obtaining assignment factors including performance objectives associated with the data objects; and
automatically identifying the schedule based on evaluating the data analytics over the historical data according to the assignment factors.
